(19) United States
(12) Patent Application Publication
(10) Pub. No.: US 2009/0217263 A1
(43) Pub. Date: Aug. 27, 2009

(54) VIRTUAL APPLIANCE FACTORY

(76) Inventors: Alexander Gebhart, Akazienweg (DE); Erol Bozak, Vinzentiusstrasse (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/037,053

(22) Filed: Feb. 25, 2008

(51) Int. Cl. G06F 9/455

(52) U.S. Cl. 718/1

(57) ABSTRACT

Methods and apparatus, including computer program products, are provided for generating virtual appliances. In one aspect, there is provided a computer-implemented method. The method may include receiving, from a user interface, information representative of one or more selections of solutions. The one or more solutions may represent a configuration of a virtual appliance. The virtual appliance may be generated based on the received information. The generated virtual appliance may be provided to another machine to enable the other machine to execute the virtual machine. Related apparatus, systems, methods, and articles are also described.

### FIELD

The present disclosure relates to virtual machines, such as virtual appliances.

### BACKGROUND

Computers have now become an integral part of our society both in business and in residential settings. Almost every business of sufficient size in Germany, the United States, and other developed countries has one or more computers to assist them in running their businesses. Similarly, many families in those countries now have computers at home that are used to run various applications, including games.

Some attribute the popularity of computers to the Internet. The Internet provides people with a ready access to vast amounts of data. Many people now get their news, sports, stock, entertainment, and other information primarily from the Internet. But businesses have also embraced the Internet. The Internet provides the opportunity for computers to communicate instantly with other computers or individuals. Business processes that were once restricted to intranets and their users are now moving to the Internet. Accordingly, companies are moving more and more of their data to electronic forms. In addition, companies have amassed huge amounts of data in an effort to understand their business, improve performance, and build stronger employee, customer, and partner relationships.

Virtualization technology provides a mechanism for optimizing processing. Virtualization technology provides a software layer that when executed allows multiple virtual machines with, in some cases, different operating systems to run side-by-side with other virtual machines running on the same physical machine (e.g., a node, a computer, a processor, a server, and the like). The virtualization software provides a so-called “container” that wraps and isolates the virtual machine from other virtual machines. For example, in a server complex including fifty physical servers, each of which hosts its own application server, virtualization permits the server complex to instead operate with, for example, twenty-five physical servers, each of which includes virtualization software providing two virtual machines for the application servers. In both cases, fifty application servers are deployed, but with virtualization, the number of physical servers is reduced to twenty-five.

Virtualization technology, including virtual machines may also provide one or more of the following functions: running multiple virtual machines with different operating systems at the same time on the same physical machine; generating fully configured isolated virtual machines with a set of virtual hardware including an operating system and applications; saving, copying, and provisioning of virtual machines; and moving virtual machines from one physical machine to another physical machine for workload management.

When a virtual machine is used, the virtual machine may include an operating system and one or more applications. An operating system (OS) is the program that, after being initially loaded into a computer by a boot program, manages other programs on the computer. The other programs (also referred to as application programs or programs) may use the operating system by making requests for services through one or more application program interfaces (APIs) of the operating system. An application may perform one or more specific functions (or tasks) directly for a user or, in some cases, another program or application program. Examples of applications include spreadsheets, word processing, browsers, databases, and the like. For example, a virtual machine may include an operating system, such as Linux or Windows Vista, and one or more application programs, such as a browser, all of which operate in the so-called “container” provided by the virtual machine.

In some cases, the virtual machine may also include some data for use by the application. When this is the case, the virtual machine may be referred to as a virtual appliance. The phrase “virtual appliance” refers to an example of a virtual machine that may include the application, operating system, and other items (e.g., data, drivers, etc.) to enable simplification of the installation and the configuration process associated with running the application. An example of a virtual appliance is the MediaWiki software that powers Wikipedia, which is available as a virtual appliance. The MediaWiki appliance contains all the necessary software, including operating system, database, and MediaWiki, to run a wiki installation as a so-called “black box.”

### SUMMARY

The subject matter disclosed herein provides methods and apparatus, including computer program products, for generating virtual appliances.

In one aspect, there is provided a computer-implemented method. The method may include receiving, from a user interface, information representative of one or more selections of solutions. The one or more solutions may represent a configuration of a virtual appliance. The virtual appliance may be generated based on the received information. The generated virtual appliance may be provided to another machine to enable the other machine to execute the virtual machine.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts a block diagram of a system 100 including a virtual appliance factory;

FIG. 2 depicts a block diagram of a virtual appliance;

FIG. 3 depicts a process 300 for providing a virtual appliance generated based on selection(s) provided by a user interface;

FIG. 4 depicts a user interface including selection(s) used to generate a virtual appliance; and

FIG. 5 depicts the system 100 after the virtual appliance has been generated.

Like labels are used to refer to same or similar items in the drawings.

### DETAILED DESCRIPTION

Virtual appliances are encapsulated, self-contained solutions based on virtual machines. The virtual appliance is self-contained as most (if not all) of the software components and required operating system resources are encapsulated within the virtual appliance. The virtual appliance may be provided to a physical machine, such as a computer, in the form of an image (a virtual machine image). An image refers to an executable copy of program code.

The subject matter described herein provides a virtual appliance factory. The virtual appliance factory may perform one or more of the following: receiving selections configuring the virtual appliance; retrieving solutions (e.g., components, program code, applications, applets, software, and the like) for the virtual appliance based on the received selection; generating the virtual appliance (including an image) using the retrieved solutions; provisioning the virtual appliance; instantiating the virtual appliance; testing the virtual appliance; and providing the virtual appliance (or an image of the virtual appliance) to another machine to enable execution of the virtual machine. The virtual appliance factory thus generates the virtual appliance and the virtual appliance image, so that the virtual appliance (or image) may be instantiated at another machine, such as a customer's computer.

Although virtual appliances are available from so-called “virtual appliance marketplaces,” these marketplaces provide predefined solutions (i.e., defined by the marketplace rather than a user downloading and/or purchasing the virtual appliance). As such, these virtual appliance marketplaces do not offer the option to provision a virtual appliance solution and generate a virtual appliance on demand. The subject matter described herein provides a virtual appliance factory to enable generation of the virtual appliance on demand, i.e., generate, based aspects defined by a user, the virtual appliance. Moreover, the virtual appliance factory described herein enables users to select their own solutions (e.g., components, program code, applications, applets, software, and the like), incorporated by the virtual appliance factory virtual when generating, on demand, the virtual appliance. In some implementation, the virtual appliance factory described herein may accept payment for a virtual appliance, generates, based aspects defined by a user (e.g., a purchaser), and then provides the generated virtual appliance.

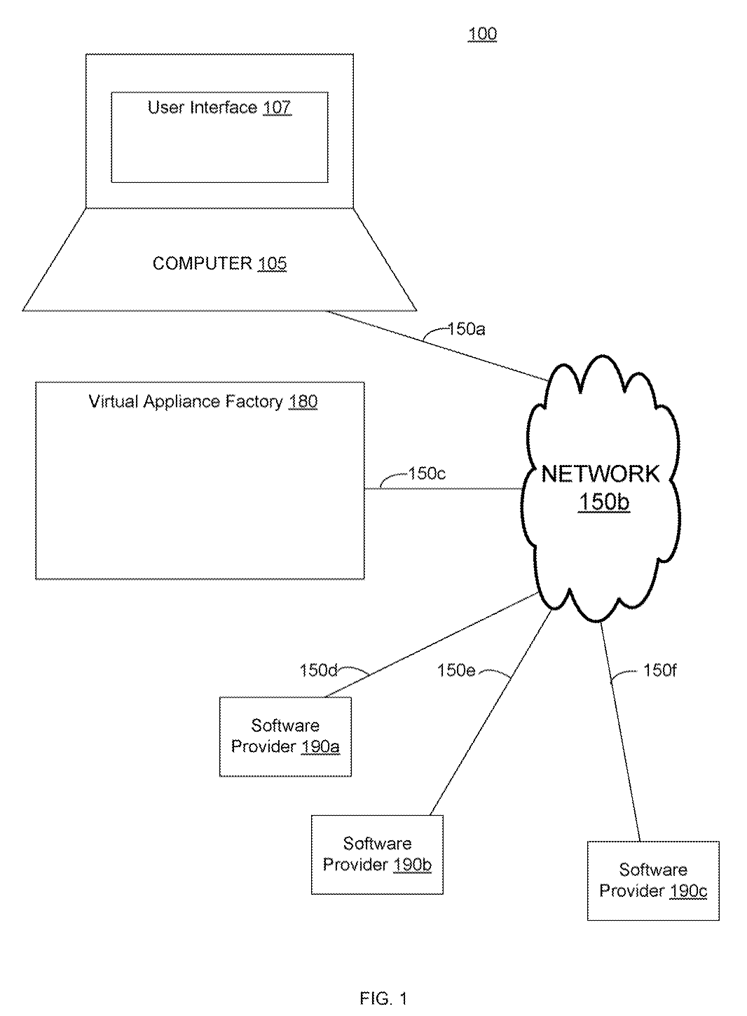

FIG. 1 depicts a system 100 including a computer 105, a virtual appliance factory 180, and one or more software providers 190a-c, all of which are coupled by a network 150a-f.

The computer 105 (e.g., a processor, a server, a blade, and the like) further includes a user interface 107. User interface 107 may be implemented as any type of interface that enables interaction with components of system 100, including virtual appliance factory 180 and software providers 190a-c. For example, user interface 107 may be implemented as a browser (e.g., Netscape Navigator) or a client application to interface with (and/or access) virtual appliance factory 180.

Virtual appliance factory 180 may be implemented as a service, such as a Web service, although virtual appliance factory 180 may also be implemented programmatically accessible through an application program interface (API). A factory refers to, in object-oriented programming, a class that is used to create one or more instances of another class. Virtual appliance factory 180 may thus be implemented as a class used to create instances (e.g., virtual appliances and/or images of virtual appliances). Virtual appliance factory 180 may provide one or more of the following: receiving selections configuring the virtual appliance; retrieving solutions (e.g., components, program code, applications, applets, software, data and the like) based on the received selection; generating the virtual appliance (including an image) using the retrieved solutions; provisioning the virtual appliance; instantiating the virtual appliance; testing the virtual appliance; and providing the virtual appliance (or an image of the virtual appliance) to another machine to enable execution of the virtual machine. Virtual appliance factory 180 may also access metadata to configure the generated virtual appliance. Metadata may describe how to configure the solutions selected for the virtual appliance. For example, the metadata (also referred to as data) may include configuration information describe how to configure a virtual machine, an application, and operating system, where to send the virtual appliance, and the like. Furthermore, the metadata may include information provided by a user at user interface 107, when making selections of solutions for the virtual appliance.

Software providers 190a-c each represent a source of solutions, such as components, program code, applications, applets, data, software, and the like. For example, a software provider may provide one or more of the following: an operating system, an application, a virtual machine, metadata, software licenses, and the like. Although FIG. 1 depicts three software providers 190a-c, there may be any number of software providers as well. Moreover, although FIG. 1 depicts computer 105 as separate from software providers 190a-c, in some implementations computer 105 may be a software provider as well.

Network 150a-f may be any type of communications mechanism and may include, alone or in any suitable combination, intra-process communications, the Internet, an intranet, or any other communication mechanism (e.g., a telephony-based network, a local area network (LAN), a wide area network (WAN), a dedicated intranet, a wireless network, and a bus). Moreover, network 150a-f may be embodied using bi-directional, unidirectional, or dedicated communication links. Network 1501a-f may also support standard transmission protocols, such as Transmission Control Protocol/Internet Protocol (TCP/IP), Hyper Text Transfer Protocol (HTTP), SOAP, WS-RM, RPC, or other protocols.

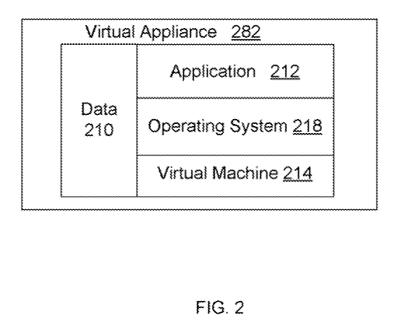

FIG. 2 depicts an example of virtual appliance 282. The virtual appliance 282 may include a virtual machine, such as virtual machine 214, an application 212, an operating system 218, and data 210 to enable configuration and/or operation of virtual appliance 282. Virtual machine 214 may be implemented at a physical machine, such as at computer 105 as well as any other location. Application 212 may correspond to any program, including a browser, a word processing application, a customer relationship management (CRM) application, an enterprise resource planning (ERP) application, a product lifecycle management application, a supply chain management (SCM) application, a supplier relationship management application, as well as any other application, service, Web service, applet, component of an application, and the like. Operating system 218 may be implemented as any operating system, including Microsoft Windows, Microsoft Vista, Java, Sun OS, Linux, or any other operating system. Virtual machine 214 may be implemented as a hypervisor 119 (also referred to as a virtual machine controller or, more simply, a controller) to control one or more virtual machines (e.g., control (or manage) the physical machine's processor, memory, and other resources enabling the virtual operating environment). VMWare ESX and VMware Server are examples of hypervisors for virtualizing an operating environment, including IP (Internet Protocol) addresses, registries, and other aspects normally used at a computer. Moreover, the hypervisor may provide an operating system, such as operating system 218.

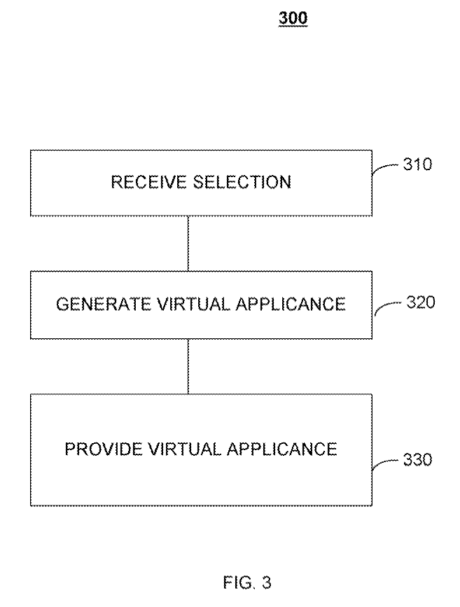

FIG. 3 depicts a process 300 for generating a virtual appliance on demand, i.e., generates the virtual appliance based aspects defined by a user.

At 310, a selection is received. The selection may be received by virtual appliance factory 180 from user interface 107. The selection may be received as a message including information indicative of the solutions selected at user interface 107. For example, a user at user interface 107 may select one or more solutions available from virtual appliance factory 180. The solution may be applications, services, applets, data, and the like. In some cases, virtual appliance factory 180 includes the solutions; while in other cases virtual appliance factory 180 retrieves the solutions from software providers 190a-c; yet in other cases, virtual appliance factory 180 retrieves the solution from a location specified by user interface 107 (e.g., a location identifying a solution, such as an operating system or an application licensed by the user). The received selection may also include information representing a purchase (e.g., credit card information and the like) of the virtual appliance (and/or its solutions) at virtual appliance factory 180.

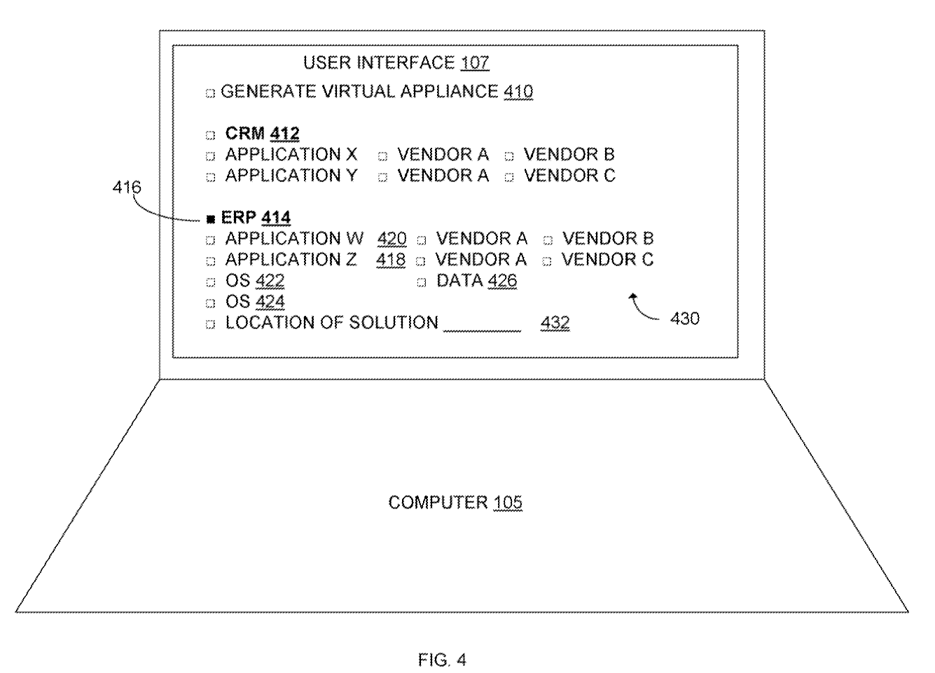

FIG. 4 depicts an example of a user interface, such as user interface 107 presenting solutions available at virtual appliance factory 180. A user may select which application to generate as a virtual appliance. In the example of FIG. 4, a user may select from different types of applications, such as a CRM application 412 or an ERP application 414. ERP application 414 may be selected 416 (e.g., by clicking an icon at user interface 107). Once an application type is selected, a user may select from one or more solutions, such as applications 418 and 420, operating systems (labeled OS) 422 and 424, data 426 (e.g., a source of data for use with the application and/or metadata). Vendors 430 (e.g., sources, such as software providers 190a-c, computer 105, and the like) for those solutions may also be selected. A user may also provide a location of a solution 432. Once all of the selections have been made, a user may select generate virtual appliance 410. The selections made at user interface 107 are then provided (e.g., as a message) to network 150a-c and virtual appliance factory 180, where the selections are received at 310. Although the above-example describes user interface 107 providing the selections before generation 320, selections related to the virtual appliance being generated may be provided at anytime including during and after generation (320) or providing (330).

At 320, virtual appliance factory 180 may generate the virtual appliance based on the selections received at 310. To generate the virtual appliance, virtual appliance factory 180 may perform one or more of the of the following: retrieving solutions (e.g., components, program code, applications, applets, software, data and the like) based on the received selection(s); generate the virtual appliance using the retrieved solutions; access metadata (and/or received information from user interface 107) to configure the generated virtual appliance; provisioning the generated virtual appliance; instantiate the virtual appliance; test the virtual appliance; generating a virtual image of the virtual appliance; and provide the virtual appliance (and/or an image of the virtual appliance) to another machine to enable execution of the virtual machine.

To retrieve solutions based on the received selections of 310, virtual appliance factory 180 may retrieve solutions from one or more software providers 190a-c. Moreover, virtual appliance factory 180 may provision any obtained solutions. For example, to provision a solution, virtual appliance factory 180 may provision software licenses and provision user accounts (e.g., establish user accounts, passwords, access to databases, access to networks, and the like). Provisioning may be performed either directly by virtual appliance factory 180 or through another component, such as through a software provider or user interface 107.

To generate the virtual appliance, virtual appliance factory 180 may configure the retrieved solutions. Virtual appliance factory 180 may also use metadata to configure the retrieved solutions. For example, the metadata may describe the configuration including the start-up sequence and initial state of the solutions (e.g., virtual appliance 282, application 212, operating system 218, virtual machine 214, and data 210) depicted at FIG. 2. The metadata may be formatted as a script to configure the virtual appliance and the components therein. Moreover, the metadata may be provided by user interface 107.

In some implementations, generation of virtual appliance 282 may be performed on-site. For example, a user at user interface 107 may provide a pre-configured image of an operating system (e.g., the operating system image may be created either by factory-compatible virtualization software where the virtual image is generated or created through a separate image creation facility where a running OS is imaged by an image creator agent provided by the factory), so that the virtual appliance factory 180 may generate the virtual appliance. In some implementations, generation of virtual appliance 282 may be performed by virtual appliance factory 180 online. In the online case, the operating system image is generated and instantiated at the virtual image factory 180. In any case, virtual appliance factory 180 may allow access by user interface 107 to customize the components of the solution, such as the operating system image.

Once generated, virtual appliance factory 180 may instantiate the virtual appliance so that it can be executed. Once instantiated, virtual appliance factory 180 may also allow access by user interface 107 to further customize the instantiated virtual appliance. Virtual appliance factory 180 may also test the virtual appliance. When testing is complete, virtual appliance factory 180 may provide an indication to user interface 107 of whether the testing was acceptable. The user of user interface 107 may then indicate at user interface that an image should be generated of the virtual appliance and that the generated image should be provided to another machine (e.g., computer 105) for execution.

For example, after a user at user interface 107 selects the solutions, the selections are provided to virtual appliance factory 180. The virtual appliance factory 180 may then generate the virtual appliance on demand, i.e., generate the virtual appliance based aspects defined by a user. In some implementations, a user at user interface 107 may request a solution (e.g., a component) already licensed by the user; as such, the user may not need to obtain additional licenses when generating the virtual appliance. When that is the case, virtual appliance factory 180 may retrieve the solutions from a location (e.g., a uniform resource locator (URL)), such as a location provided at user interface 107. For example, the solution already licensed by the user may be an operation system. In this example, a user may define that the operating system used for the virtual appliance.

The user may customize the generation of the virtual appliance image by requesting on-site testing of the virtual appliance image before the virtual appliance image is provided (e.g., sent by a message to computer 105 or another computer, processor, blade, and the like). When that is the case, the virtual appliance image is instantiated at virtual appliance factory 180 and tested remotely (e.g., by a remote component or by the user of user interface 107). Once testing of the virtual appliance is complete, the virtual appliance image is ready for deployment (e.g., sent to another machine, such as computer 105 for instantiation). Virtual appliance factory 180 may send a message to user interface 107 to indicate that testing is complete and the virtual appliance (or its image) has been deployed for use.

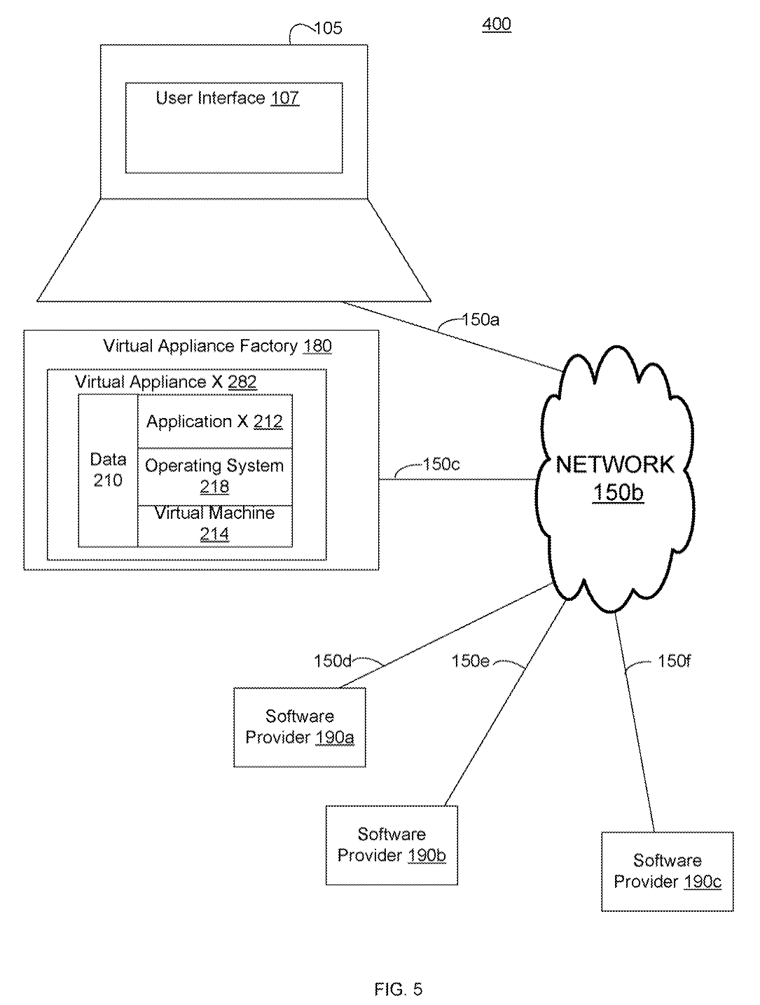

FIG. 5 depicts system 100 after virtual appliance factory 180 generated a virtual appliance 282 at 320. Virtual appliance 282 may include one or more solutions (e.g., application 212, operating system 218, virtual machine 214, and data 210) obtained from one or more software providers 190a-c as well as other locations, such as computer 105. Moreover, virtual appliance factory 180 may also configure the virtual appliance 282 and test virtual appliance 282.

Referring again to FIG. 3, at 330, virtual appliance factory 180 may provide the virtual appliance. For example, virtual appliance factory 180 may provide (e.g., send) the generated virtual appliance as an image (“virtual appliance image”) to a computer, so that the virtual appliance may be instantiated and thus executed. Referring again to FIG. 5, virtual appliance factory 180 may provide virtual appliance 282 as an image to another machine, such as computer 105, so that the other machine can instantiate and thus run virtual appliance 282.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially generated for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to generate a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Moreover, although the subject matter described above was described with respect to virtual appliances, the appliances may be implemented as virtual machines appliances as well.

The foregoing description is intended to illustrate but not to limit the scope of the invention, which is defined by the scope of the appended claims. Other embodiments are within the scope of the following claims.

What is claimed is:

1. A computer-readable medium containing instructions to configure a processor to perform a method, the method comprising:
receiving, from a user interface, information representative of one or more selections of solutions, the one or more solutions representative of a configuration of a virtual appliance;
generating, based on the received information, the virtual appliance; and
providing the virtual appliance to another machine to enable the other machine to execute the virtual appliance.

2. The computer-readable medium of claim 1, wherein receiving further comprises:
receiving, at a virtual appliance factory, information representative of the one or more selections, the one or more solutions available from the virtual appliance factory.

3. The computer-readable medium of claim 1, wherein receiving further comprises:
receiving, as a message, information representative of a location identifying at least one of the solutions.

4. The computer-readable medium of claim 1, wherein receiving further comprises:
receiving information representative of an application being selected to be included in the virtual appliance.

5. The computer-readable medium of claim 1, wherein receiving further comprises:
receiving, as a message, information representative of at least one of the solutions being licensed by a user of the virtual appliance; and
generating the virtual appliance using the licensed solution.

6. The computer-readable medium of claim 1, wherein receiving further comprises:
receiving information representing a purchase of the virtual appliance.

7. The computer-readable medium of claim 1, wherein generating further comprises:
retrieving, based on the received selection, a solution including at least one of a component, a program code, an application, an applets, and data.

8. The computer-readable medium of claim 1, wherein generating further comprises:
receiving metadata to configure the virtual appliance;
provisioning the generated virtual appliance;
instantiating the virtual appliance;
generating an image of the virtual appliance; and
testing the virtual appliance.

9. The computer-readable medium of claim 1, wherein providing further comprises:
providing an image of the virtual appliance to the other machine.

10. A computer-implemented method comprising:
receiving, from a user interface, information representative of one or more selections of solutions, the one or more solutions representative of a configuration of a virtual appliance;
generating, based on the received information, the virtual appliance; and
providing the virtual appliance to another machine to enable the other machine to execute the virtual appliance.

11. The computer-implemented method of claim 10, wherein receiving further comprises:
receiving, at a virtual appliance factory, information representative of the one or more selections, the one or more solutions available from the virtual appliance factory.

12. The computer-implemented method of claim 10, wherein receiving further comprises:
receiving, as a message, information representative of a location identifying at least one of the solutions.

13. The computer-implemented method of claim 10, wherein receiving further comprises:
receiving information representative of an application being selected to be included in the virtual appliance.

14. The computer-implemented method of claim 10, wherein receiving further comprises:
receiving, as a message, information representative of at least one of the solutions being licensed by a user of the virtual appliance; and
generating the virtual appliance using the licensed solution.

15. The computer-implemented method of claim 10, wherein receiving further comprises:
receiving information representing a purchase of the virtual appliance.

16. A system comprising:
a processor; and
a memory, wherein the processor and the memory are configured to perform a method comprising:
receiving, from a user interface, information representative of one or more selections of solutions, the one or more solutions representative of a configuration of a virtual appliance;
generating, based on the received information, the virtual appliance; and
providing the virtual appliance to another machine to enable the other machine to execute the virtual appliance.

17. The system of claim 16, wherein receiving further comprises:
receiving, at a virtual appliance factory, information representative of the one or more selections, the one or more solutions available from the virtual appliance factory.

18. The system of claim 16, wherein receiving further comprises:
receiving, as a message, information representative of a location identifying at least one of the solutions.

19. The system of claim 16, wherein receiving further comprises:
receiving information representative of an application being selected to be included in the virtual appliance.

20. The system of claim 16, wherein receiving further comprises:
receiving, as a message, information representative of at least one of the solutions being licensed by a user of the virtual appliance;
generating the virtual appliance using the licensed solution.
receiving metadata to configure the virtual appliance;
provisioning the generated virtual appliance;
instantiating the virtual appliance;
generating an image of the virtual appliance; and
testing the virtual appliance.
